(19) United States
(12) Patent Application Publication
(10) Pub. No.: US 2005/0043960 A1
(43) Pub. Date: Feb. 24, 2005

(54) System and automate the licensing, re-use and royalties of authored content in derivative works

(76) Inventor: David Blankley, New York, NY (US)

Correspondence Address: Philip M. Weiss;Weiss & Weiss, 310 Old Country Road, Garden City, NY, 11530, US

(21) Appl. No.: 10/644,218

(22) Filed: Aug. 19, 2003

(51) Int. Cl. G06F 17/60

(52) U.S. Cl. 705/1; 705/500

(57) ABSTRACT

A system and method which allows authors to automate the licensing and distribution process to enable their works to be safely included in derivative works, regardless of the industry.

### FIELD OF THE INVENTION

The present invention relates to a system and method which allows authors to automate the licensing and distribution process to enable their works to be safely included in derivative works, regardless of the industry.

### BACKGROUND OF THE INVENTION

Most current digital royalty systems assume a cost per use of digital assets fee structure. Other systems assume a fixed cost over some subscription period for a collection of content and disperse the royalties among the authors.

While effective at sales of single units to end consumers, these methods do not allow for effective reuse of the content for the production and redistribution of derivative works. For example, a song writer may download music and set a song to it. However, in order to re-distribute this work the writer must contact various publishers, intermediaries, and artists before his song and the music may be distributed together. This is clearly an expensive and time-consuming process which detracts from the artist's time to do what they do best: produce content.

Another example is the video game industry. Modem games have multiple types of artistic content, such as models, textures, maps, general image files, sound effects, etc. Game developers that have already created the content may wish to leverage their existing investment by making the content available to other developers to re-use. However, the marketing and legal costs of this can quickly make the proposition not cost effective. Other game developers may wish to re-use this content in a Lego-block like fashion to produce a derivative work, which could be significantly different than the original proposal, but, as with song writers the expenses involved and lack of streamlined process quickly detract from the proposition's value.

U.S. Pat. Nos. 6,314,409, 5,933,498 and US Publication No. 2001/0021926 relate to a system for controlling access and distribution of digital property. Portions of the data are protected and rules concerning access rights to the data are determined. A method is also provided for distributing data for subsequent controlled use of the data.

U.S. Pat. No. 6,236,971 and US patent publication Nos. 2003/0069849 and 2001/0010045 relate to a system for controlling the distribution and use of digital works using digital tickets. A digital ticket is used to entitle the ticket holder to exercise some usage right with respect to a digital work. Usage rights are used to define how a digital work may be used or distributed. Each usage right may specify a digital ticket which must be present before the right may be exercised. Digital works are stored in repositories which enforce a digital works usage rights. Each repository has a generic ticket agent which punches tickets.

U.S. Pat. No. 6,135,646 relates to a system for uniquely and persistently identifying, managing, and tracking digital objects. Holders of rights in digital objects are enabled to control terms and conditions under which they are accessed by users in a network, or are granted by others.

U.S. Pat. No. 5,765,152 relates to a system and method for managing copyrighted electronic media. Copyrighted electronic media are packaged in a secure electronic format, and registered on associated registration server, which serves to provide on-line licensing and copyright management for that media. Users are connected to the server to enable data transfers and to transact licenses to utilize the media. Packaged electronic media are typically created by an author or derivative user of the work. Once the packaged media is registered on the server, the media is made available for limited use and possible license through an authorization server. The limited use is specified within the minimum permissions data set assigned to each packaged media. Without a license, users are typically permitted to view the packaged media through a system which unpackages the media, but cannot save or otherwise transfer the media without obtaining auxiliary permissions to do so from the authorization server.

U.S. Pat. No. 5,715,403 relates to a system for controlling the distribution and use of digital works having attached usage rights where the usage rights are defined by a usage rights grammar. The usage rights define how the individual digital work may be used and distributed. Instances of usage rights are defined using a flexible and extensible usage rights grammar. A right in the usage rights grammar is a label associated with a predetermined behavior and conditions to exercising the right.

U.S. Pat. No. 5,638,443 relates to a system for controlling the distribution and use of composite digital works. A digital work is comprised of a description part and a content part. The description part contains control information for the composite digital work. The content part stores the actual digital data comprising the composite digital work. The description part is logically organized in an acrylic structure. For a composite digital work each node of the acrylic structure represents an individual digital work or some distribution interest in the composite digital work. A node in the acrylic structure is comprised of an identifier of the individual work, usage rights for the individual digital work and a pointer to the digital work. Composite digital works are stored in repositories. A repository has two primary operating modes, a server mode and a requester mode. When operating in a server mode, the repository is responding to requests to access digital works. When operating in requester mode, the repository is requesting access to a digital work. A repository will process each request to access a composite digital work by examining the usage rights for each individual digital work found in the description part of the composite digital work.

U.S. Pat. No. 5,634,012 relates to a system for controlling the distribution and use of digital works having a fee reporting mechanism. Usage rights and fees are attached to digital works. The usage rights define how the digital work may be used or further distributed. The digital works and their usage rights and fees are stored in repositories. The repositories control access to the digital works. Upon determination that the exercise of a usage rights requires a fee, the repository generates a fee reporting transaction. Fee reporting is done to a credit server. The credit server collects the fee information and periodically transmits it to a billing clearinghouse.

U.S. Pat. No. 5,629,980 relates to a system for controlling the distribution and use of digital works. The owner of a digital work attaches usage rights to that work. Usage rights are granted by the owner of a digital work to buyers of the digital work. The usage rights define how a digital work may be used and further distributed by the buyer. Each right has associated with it certain optional specifications which outline the conditions and fees upon which the right may be exercised. Digital works are stored in a repository. Digital work playback devices, coupled to the repository containing the work, are used to play, display or print the work.

US Publication No. 2003/0115144 relates to a digital work for use within a rights management system or controlling use of the digital work in accordance with usage rights. The work is organized into acyclic structure and includes a contents file including information related to content that can be interpreted by an interpreter, and a description tree file including descriptor blocks organized in a hierarchical manner.

US Publication No. 2003/0046093 relates to a rights management system. The apparatus can provide the core for license repository and automated rights management services.

US Publication No. 2002/0178082 relates to a method and apparatus for generating and distributing creative works. The invention provides a cooperative auction means collecting funds for payment for inducing a rightholder to donate rights in a piece of intellectual property to the public domain.

US Publication No. 2002/0133465 relates to a usage rights grammar and digital works having usage rights created with the grammar. The usage rights specify a manner of use indicating one or more stated purposes for which the digital work can be at least one of used and distributed by an authorized party.

US Publication No. 2002/0128972 relates to digital works having usage rights and method for creating the same. A digital work is adapted for being distributed within a system for controlling at least one of the distribution and use of digital works. The digital work includes: digital content representing a portion of a digital work suitable for being rendered by a rendering device and usage rights associated with the digital content.

US Publication No. 2003/0023561 relates to a system for controlling the distribution and use of digital works using digital tickets. A digital ticket entitles to ticket holder to exercise some usage right with respect to a digital work. Digital works are stored in repositories which enforce a digital works usage right. Each repository has a generic ticket agent which punches the ticket.

U.S. Pat. No. 5,933,498 relates to a system for controlling access and distribution of digital property. Portions of the data are protected and rules concerning access rights to the data are determined. A method is provided for distributing data for subsequent controlled use of those data. A device is provided for controlling access to data having protected data portions and rules concerning access rights to the data.

US Publication No. 2003/0028651 relates to a proprietary information utility which includes an interface that provides outside entities connection to the proprietary information utility. A repository contains proprietary information. The repository is compartmentalized by user identity and entitlement. A security system limits access of each user connecting to the proprietary information utility to proprietary information to which the user is entitled. A billing system tracks usage of users of the proprietary information utility for billing purposes.

U.S. Pat. Nos. 4,827,508 and 4,977,594 relate to a database usage metering, billing and protection system and method. The system includes a hardware device which is plugged into a computer system bus and a software program system resident in the hardware device. One or more databases are encrypted and stored on a non-volatile mass storage device. A tamper-proof decrypting device and associated controller decrypts selected portions of the stored database and measures the quantity of information which is decrypted. This measured quantity information is communicated to a remote centralized billing facility and used to charge the user a fee based on database usage.

US Publication No. 2003/0037253 relates to a digital rights management system. The system relates to a software application which provides means to control the interaction between a client's computer and a remote server on which the invention and the creative work of an author reside. The invention has a series applets that selectively disable certain functions including, save file, print file, download file, copy and save, contained in most existing browsers.

### SUMMARY OF THE INVENTION

The system of the present invention allows authors to automate the licensing and distribution process to enable their works to be safely included in derivative works, regardless of the industry. In the process the present invention creates a “royalty payment value chain” giving rise to a new collaborative content creation environment allowing multiple authors to participate in the generation of both new and derivative works in a manner which ensures equitable financial participation.

The present invention relates to a system to automate licensing, re-use, and royalties of author content and derivative works which comprises a data base which allows an author to upload content. The system organizes the content by author, title of content, description of content, or re-use methodology. It is an object of the present invention to provide information to contact the original author. It is an object of the present invention for the re-use methodology to describe how the content can be used and what fees are entailed. It is an object of the present invention for the fee to be selected from a flat fee, royalty from direct user, royalty from final end work creator, or combination thereof.

It is an object of the present invention to allow a user to aggregate works from different authors, view the aggregate work and integrate the work to create the derivative work. It is an object of the present invention for the derivative work to be put into the system and be used as a further derivative work. It is an object of the present invention for the system to provide logical rules on how to use the content.

It is an object of the present invention for the system to provide the author with rules for use of the content and for the author to choose the rules and send them back to the system. It is an object of the present invention for the rules to include fees. It is an object of the present invention for the system to determine content contributors and royalty allocations. It is an object of the present invention for the system to inform the authors of use of their content. It is an object of the present invention for the system to log activity of the users and determine royalty allocation for the authors. It is an object of the present invention for the system to bill users periodically and disperse funds to the authors. It is an object of the present invention for the system to check for duplicate content, and if the duplicate content is found, then the system does not post the duplicate content.

There are a variety of different industries in which the present invention can be applied. Since several of the industries are mature, and have established modes of operating, there can be differences in the implementation. A good example of this is to juxtapose the Video Game and Movie industry examples.

It is an object of the present invention to provide the system and method to the Video Game Industry. It is an object of the present invention to allow a video game artist to upload his collection of textures on to the upload server of the present invention. It is an object of the present invention to allow the user to provide their name description and re-use methodology for their work as well as other meta data, such as whether the person may be contacted by other authors.

It is an object of the present invention for the re-use methodology to describe how other content creators may use the content, and the fees entailed. It is an object of the present invention for this list to include a list of creators that may use the content, may not use the content, whether the creator wants a flat fee, a royalty from any direct users, a royalty from the final end work creator or any combination thereof.

It is an object of the present invention to provide a system and method to allow a game designer a way to aggregate all the components available for re-use, view the new textures and decide whether to integrate them into their project. It is an object of the present invention to allow a game designer to include works of other artists in derivative works, and the original creator of the work will automatically generate revenue from the results of the derivative work.

It is an object of the present invention for the finished project to be made available on the system of the present invention. The system of the present invention can be a service which can take one of several common business forms, such as a simple download service, a publishing business aggregating it's authors, or an online subscription service which pays out royalties to authors as a percentage of revenue.

It is an object of the present invention for authors to generate revenue from a system which enables loosely coupled artists to collaborate in a non-compulsory fashion.

It is an object of the present invention to provide a system that allows an, “Author”, “Collaborator” and “Final Uploader” to interact with the system. It is an object of the present invention to provide logic rules for how to deal with the meta data, and storage capacity.

It is an object of the present invention to connect an author to a content repository. It is an object of the present invention to send meta data from the author to the content repository. It is an object of the present invention to send content from the author to the content repository. It is an object of the present invention to allow a collaborator or to connect to the content repository. It is an object of the present invention to allow a collaborator to download content from the content repository.

It is an object of the present invention to allow a final uploader to connect to the content repository. It is an object of the present invention for a final uploader to upload aggregate content and meta data to the content repository. It is an object of the present invention for the system of the present invention to determine content contributors and royalty allocations. It is an object of the present invention to inform all contributors regarding the use of their content. It is an object of the present invention to make available the new content to consumers.

Is an object of the present invention for a user to connect to the system and for the system to track what content the user accesses. It is an object of the present invention for the system to collect subscription fees for the publisher from the user and to log the activity of the user to determine the royalty allocation.

It is an object of the present invention for the billing node to access all accounts due to be billed. For each account the users credit card is used. If a users account is past due, the user is denied access to the system.

It is an object of the present invention for the system to periodically determine royalties owed to each author and disburse the funds. It is an object of the present invention for the system to calculate the royalties based on the usage of each authors works. It is an object of the present invention for the publisher running the service, to determine an algorithm to be used to allocate royalties. This algorithm can vary based on the business needs of the publisher and type of content being sold. It is an object of the present invention for the publisher to set a minimum threshold usage amount before any revenues are due.

It is an object of the present invention to allow a user to post his content along with a brief description of what the content is about and set the licensing rules to allow commercial reuse. It is an object of the present invention for the system to make sure that the content being provided by the user does not match existing content on the system. If existing content is found the new content will not be uploaded to the system.

It is an object of the present invention to allow a user to search the system for descriptions of the content. It is an object of the present invention for the system to record the search by the user.

It is an object of the present invention to allow a user to upload their software library along with architectural and usage documentation to the system of the present invention. It is an object of the present invention for the user to add descriptive information as well as categorizing the product, and including licensing fees.

It is an object of the present invention to allow a user to pay a fixed unlimited usage fee, rather than a royalty licensing price.

It is an object of the present invention to allow a user who has searched the system to provide ratings concerning the content they have searched.

It is an object of the present invention to provide a script licensing service. Scripts would be available online, with the licensing terms clearly outlined. It is an object of the present invention to allow a user to “option” the script. It is an object of the present invention for the script writer to set a price for optioning the script. At this point, the buyer would pay a fee to the script writer and the script would be made unavailable to others.

It is an object of the present invention for the system to allow other script writers the opportunity to develop a script that utilizes characters or settings from another writer's work.

### DETAILED DESCRIPTION OF THE INVENTION

Process Overview:

### EXAMPLE 1

### The Video Game Industry

Rocco, a video game artist developing textures on a freelance basis, uploads his new collection of textures to the Upload Server. When uploading, Rocco provides a name, description and re-use methodology for his textures, as well as other meta data, such as whether he may be contacted by other authors.

The re-use methodology describes how other content creators may use his content, and the fees entailed. This would include a lists of creators that may use the content, may not use the content, whether Rocco wants a flat fee, a royalty from any direct users, a royalty from the final end work creator or any combination thereof.

Yanni, a game designer who has a clear vision of how to aggregate all the components available for re-use sees Rocco's new textures and decides to integrate them into his project. Rocco's work, along with the work of other artists, will now be included in Yanni's derivative work, and Rocco will automatically generate revenue from the results of Yanni's project.

Yanni, finishes his project, and makes it available on the service. The service can take one of several common business forms, such as a simple download service, a publishing business aggregating it's authors, or an online subscription service which pays out royalties to authors as a percentage of revenue.

Now, Yanni, Rocco, and other authors are all generating revenue from a system which has enabled loosely coupled artists (Yanni, Rocco, et al) to collaborate in a non-compulsory fashion.

A complete example process and system implementation are outlined in the following diagrams.

Phase 1:

This first diagram is a sequence diagram that depicts how three authors, “Author”, “Collaborator” and “Final Uploader” interact with the system, in this case an online server with logic rules for how to deal with the meta data, and storage capacity.

[image]

[image]

[image]

### EXAMPLE 2

### The Music Industry

In the music industry there are many types of artists who need to collaborate to create content. For instance, song writers, musicians and singers all provide unique content towards the integrated final product.

Doug is a freelance song writer who would like to get his songs seen by more musicians and singers. He posts his song to the service, and provides a brief description of what the song is about. He also sets the licensing rules to allow commercial re-use with a 5% of revenue fee.

The system checks to make sure that the song does not match an existing song in storage, and then stores the song and time of upload.

Kristina is a singer who is looking for an exciting new song to sing. She goes onto the service and skims the song descriptions. She looks at a couple of songs, and her review of the songs is recorded as a record should she try to take aspects of them. Finally, she finds Doug's song and immediately falls in love with it. She starts practicing the song and produces a version of the song.

From this point she can sell the song through regular industry channels, making sure she pays Doug the appropriate share of the revenue. Should she choose to fail to pay, there is a record of her downloading the song from the service, and agreeing to the licensing terms.

### EXAMPLE 3

### Software Development

Much of modem software development is done by using libraries and components that have been implemented by third parties. Currently, developers must either make their components freely available through some kind of freeware mechanism, or find sufficient funds to market their product through retail channels.

By making their libraries available to a service through which more complicated licensing arrangements than simple sale of a product can provide, it enables developers to more effectively leverage the development and sale of re-usable components.

Dan, a software engineer, writes a graphing library for an application he is working on. He sees potential for the graphing library to be re-usable in many different applications that other developers will create. So Dan uploads his library, along with architectural and usage documention, to the service. When uploading he is prompted to add some descriptive information, as well as categorizing the product, and including information about licensing fees.

Jane, another software engineer, is working on a marketing application which needs graphs. She goes on the service and finds Dan's library. Since it will be more cost effective for her, she opts to pay the fixed unlimited usage fee, rather than the royalty licensing price. She purchases the product through the service, which then pays Dan.

Jane then utilizes Dan's library to significantly cut her time to completion while increasing the reliability of her product.

Pleased with the results of using Dan's library, Jane goes back on the service and gives Dan's library a high rating, and writes a raving endorsement for his library.

Based on Jane's praises, several other developers use Dan's library, and Dan soon finds himself earning additional income from his graphing library that he needed regardless.

Jane then decides that she can effectively earn income by making her marketing application available on the service. Since it is an end product, that is fee based, rather than royalty based, she marks the product as such when uploading it. Now, others cannot make derivative works with this technology, however, they can use it. As users purchase Jane's product, the service looks at the underlying libraries, Jane's license to them, and accordingly credits the accounts of the underlying library developers, and deducts that amount from Jane's final payment.

### EXAMPLE 4

### The Movie Industry

The movie industry is another industry where multiple people work together collaboratively to create artistic content.

An example service in this space would provide a script licensing service. Scripts would be available online, with the licensing terms clearly outlined. An added twist, unique to the movie industry, would be the ability to “option” the script. For example, the script writer would set a price for optioning the script. At this point, the buyer would pay a fee to the script writer and the script would be made unavailable to others.

Another use would be to allow other script writers the opportunity to develop a script that utilizes characters or settings from another writer's work.

Jeremy, a college student taking a script writing class, decides to upload a script he wrote for an assignment to the service. He checks off a low royalty rate, and also checks the box allowing other writers the opportunity to re-use the characters and setting of his script. Michael Moviemaker reads Jeremy's script and decides to make a movie from it.

However, Michael does not want others to be able to develop the brand. He contacts Jeremy through the service. Jeremy agrees to Michael's requests, and edits his licensing terms to suit. Michael then elects to develop the script, and it is made unavailable to other subscribers.

### EXAMPLE 5

### E-Learning

E-learning curriculums and Intelligent Tutoring Systems involve the development of expert systems and knowledge bases which are used to teach students. An example service in this space would allow collaborators to contribute and create tutorials, expert systems and knowledge bases for an e-learning application.

For example, fitness experts Adrienne and Patti independently produce a series of tutorials for an exercise regime and upload it to the e-learning tutorial creation service, specifying additional meta data such as licensing terms.

Marc, a producer of exercise tutorials, likes the tutorial work developed by Adrienne and Patti. He accepts the licensing terms of both tutorials and aggregates them into a single new tutorial that he distributes.

The exercise tutorials are a great success, allowing both Adrienne and Patti to retire off the proceeds, and millions of Americans to learn proper exercise technique.

1. A method for creating derivative works comprising:
connecting an author to a content repository;
sending meta data from said author to said content repository;
sending content from said author to said content repository;
connecting a collaborator to said content repository;
downloading said content from said author to said collaborator from said content repository;
connecting a final uploader to said content repository;
uploading aggregate content and meta data from said final uploader to said content repository.

2. The method of claim 1 further comprising:
determining content contributors and royalty allocations.

3. The method of claim 1 further comprising:
notifying all contributors regarding use of said content.

4. The method of claim 1 further comprising;
tracking what content a user accesses.

5. The method of claim 1 further comprising:
collecting subscription fees for said author from a user and logging activity of said user to determine royalty allocation.

6. The method of claim 2 further comprising:
billing all users on a periodic basis based on use.

7. The method of claim 2 further comprising:
determining periodically royalties owed to each author and disbursing funds.

8. The method of claim 2 further comprising:
calculating said royalties based on usage of each authors works.

9. The method of claim 2 further comprising:
determining an algorithm to allocate royalties.

10. The method of claim 9 wherein said algorithm varies based on type of content being sold.

11. A system to automate licensing, reuse and royalties of author content and derivative works comprising:
a data base which allows an author to upload content;
said system organizing said content by author, title of content, description of content or reuse methodology.

12. The system of claim 11 further comprising information to contact said author.

13. The system of claim 11 wherein said reuse methodology describes how content can be used and fees entailed.

14. The system of claim 13 wherein said fee is selected from a flat fee, royalty from direct user, royalty from final end work creator or combination thereof.

15. The system of claim 14 wherein a user can aggregate works from different authors, view said aggregate work and integrate said work to create said derivative work.

16. The system of claim 15 wherein said derivative work is put into said system which can be used as a further derivative work.

17. The system of claim 11 wherein said system provides logical rules on how to use said content.

18. The system of claim 11 wherein said system provides said author rules to use for said content and said author chooses said rules and sends said rules back to said system.

19. The system of claim 18 wherein said rules includes fees.

20. The system of claim 11 wherein said system determines content contributors and royalty allocations.

21. The system of claim 11 wherein said system informs said authors of use of said content.

22. The system of claim 11 wherein said system logs activity of users and determines royalty allocation for said authors.

23. The system of claim 11 wherein said system bills users periodically and disburses funds to said authors.

24. The system of claim 11 wherein said system checks for duplicate content, if duplicate content is found said system does not post said duplicate content.
